(19) United States
(12) Patent Application Publication
(10) Pub. No.: US 2014/0340794 A1
(43) Pub. Date: Nov. 20, 2014

(54) TRANSFORMER MODULE

(71) Applicant: Nai-Chien CHANG, New Taipei City (TW)

(72) Inventor: Nai-Chien CHANG, New Taipei City (TW)

(21) Appl. No.: 14/271,436

(22) Filed: May 6, 2014

(30) Foreign Application Priority Data
May 14, 2013 (TW) 102208942

(51) Int. Cl. H01F 27/40

(52) U.S. Cl. CPC H01F 27/40
USPC 361/1; 361/836

(57) ABSTRACT

The transformer module comprises a transformer, a network IC module, and a body. The body has a containing space for encapsulating the transformer and the network IC module. A plurality of upper terminals is set on a top side of the transformer, and the transformer is electrically connected with the network IC module through the plurality of upper terminals, so as to stack the network IC module on the top side of the transformer. A network connector can electrically connect with the transformer and the network IC module of the transformer module in order when being connected with the transformer module through a computer mainboard.

### BACKGROUND OF THE INVENTION

1. Field of the Invention

The present invention relates to a transformer, and in particular to a transformer module which integrates the transformer and other electronic components needed by a network connector.

2. Description of Related Art

Generally, the nowadays electronic devices, especially computers are configured at least one network connector, such as RJ-45 connector for connecting to internet. User can connect the electronic device to the internet through a cable inserted to the network connector, and the computer can easily transmit data through the internet.

For using the network connector more safely, an ordinary computer is usually configured on an internal mainboard one or more components which are needed by the network connector, such as protection component, transformer, network IC, and so on.

A current problem is the above mentioned electronic components will occupy a lot of spaces of the mainboard. However, to provide the ability of processing network related signal on the mainboard, and to provide protection for the computer from probably damage brought by the network connector (for example, noise, or surge generated by suffering lightning stroke), the amount of the above mentioned electronic components can't be reduced.

As the result, how to save the space of the mainboard without reducing any electronic component is the main problem to be salve by the technical person in this field.

### SUMMARY OF THE INVENTION

The present invention is to provide a transformer module, which uses a transformer as a center core to stack another electronic components and integrates all electronic components needed by a network connector in a single body. Further, the present invention has the convenience to set the single transformer module on a computer mainboard.

The transformer module includes a transformer, a network IC module, and a body. The body has a containing space for encapsulating the transformer and the network IC module. A plurality of upper terminals is set on a top side of the transformer, and the transformer is electrically connected with the network IC module through the plurality of upper terminals, so as to stack the network IC module on the top side of the transformer. A network connector can electrically connect with the transformer and the network IC module of the transformer module in order when being connected with the transformer module through a computer mainboard.

The module of the present invention uses the transformer as a center core, and stacks electronic components which are needed by a network connector on the top side of the transformer (for example, a network IC). Therefore, all electronic components are integrated in one single body to constitute a single module.

In the other hand, the present invention can set all electronic components needed by the network connector within the single transformer module for security purpose. Therefore, the amount of the electronic components configured on the computer mainboard needs not to be reduced for saving the space of the computer mainboard, so the security of the network connector and the computer mainboard will be guaranteed.

### BRIEF DESCRIPTION OF THE DRAWINGS

FIG. 1 is a perspective view showing a usage of a transformer module of a first embodiment according to the present invention.

FIG. 2 is an exploded perspective view of the transformer module of the first embodiment according to the present invention.

FIG. 3 is a combination perspective view of the transformer module of the first embodiment according to the present invention.

FIG. 4 is a section view of the transformer module of the first embodiment according to the present invention.

FIG. 5 is a block diagram of the transformer module of the first embodiment according to the present invention.

FIG. 6 is a combination perspective view of the transformer module of a second embodiment according to the present invention.

FIG. 7 is a section view of the transformer module of the second embodiment according to the present invention.

FIG. 8 is a block diagram of the transformer module of the second embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

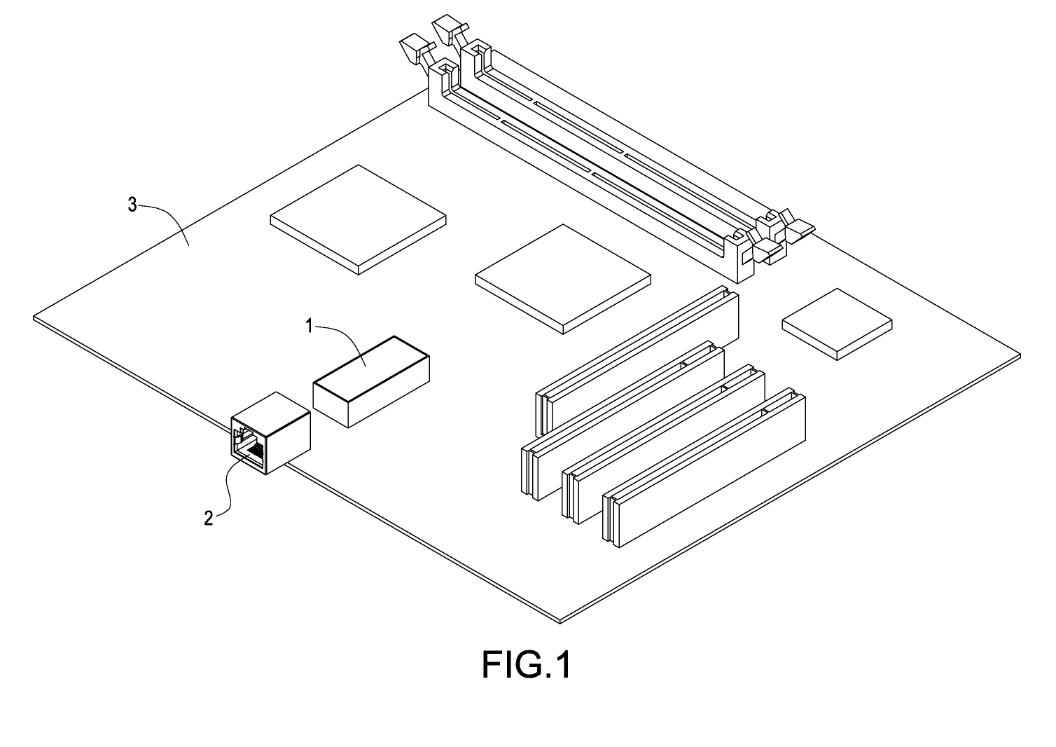

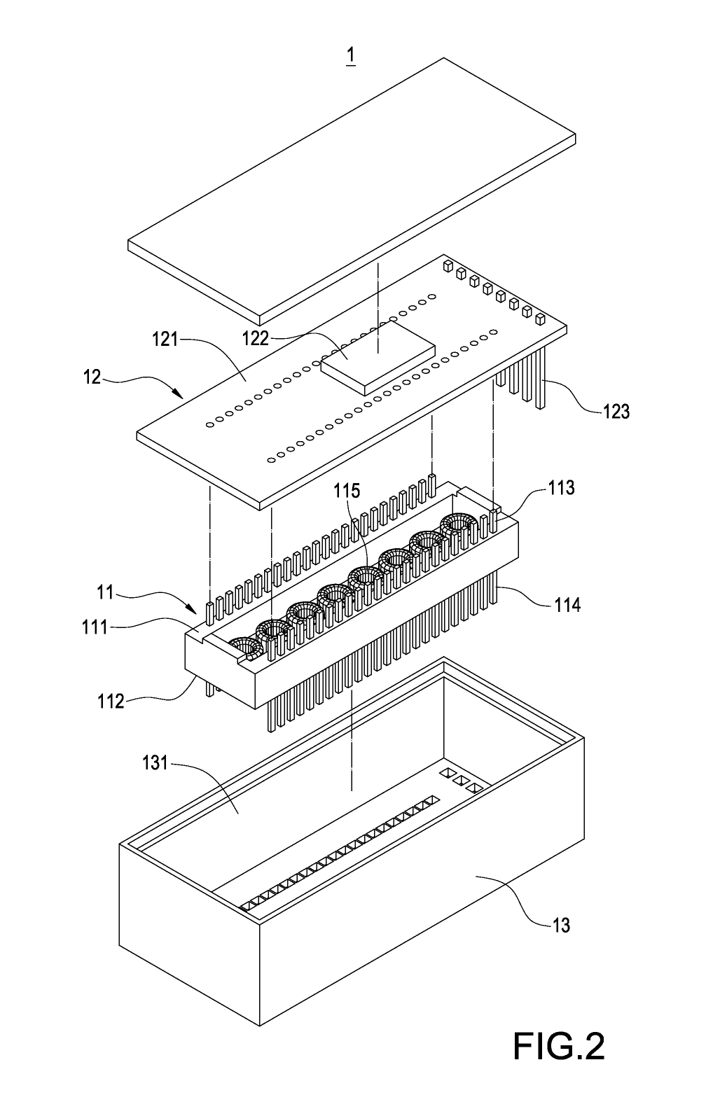

FIG. 1 is a perspective view showing a usage a transformer module of a first embodiment according to the present invention. The present invention discloses a transformer module 1, the transformer module 1 integrates not only a transformer (as the transformer 11 shown in FIG. 2), but also electronic components which are needed by a network connector 2, such as a RJ-45 connector. Therefore, a computer mainboard 3 can safely connect and use the network connector 2 by way of configuring the transformer module 1 directly, and do not need to configure other additional electronic components thereon. In this embodiment, the transform 11 can be, for example, a transformer integrated circuit (IC). Else, the transformer 11 can also be a modularized transformer which is constituted by multi-coils (as the coil 115 shown in FIG. 2), and the amount of the coil 115 can be four or eight, but not intended to limited the scope of the present invention.

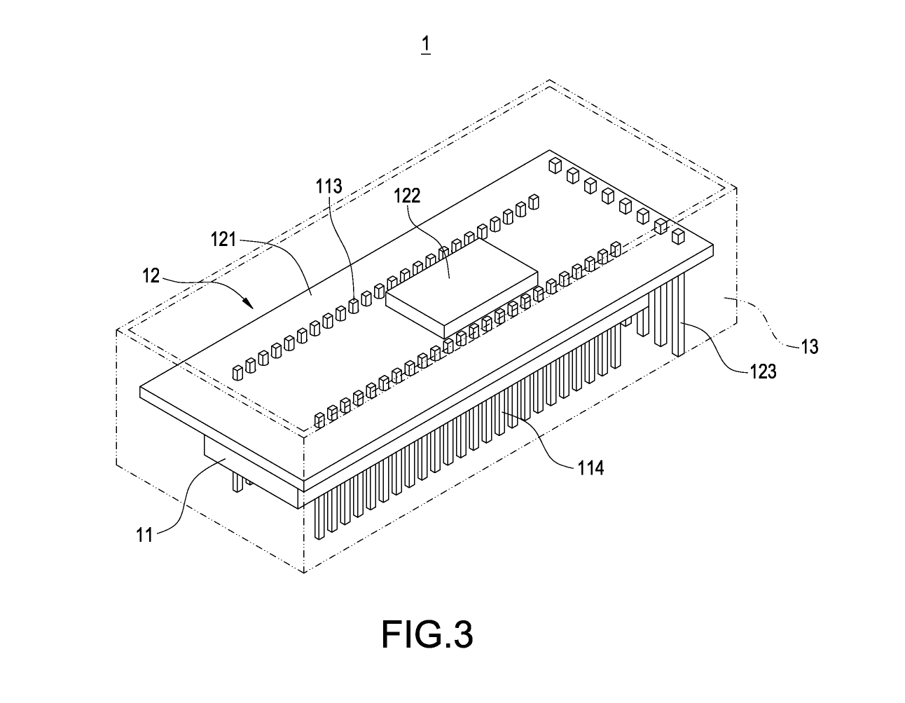

FIG. 2 is an exploded perspective view of the transformer module of the first embodiment according to the present invention. FIG. 3 is a combination perspective view of the transformer module of the first embodiment according to the present invention. As shown in FIG. 2 and FIG. 3, the transformer module 1 mainly comprises the transformer 11, a network integrated circuit (IC) module 12, and a body 13. The body 13 has a containing space 131 therein, and the containing space 131 encapsulates the transformer 11 and the network IC module 12.

The main feature of the present invention is the transformer module 1 uses the transformer 11 as a central core, and the transformer 11 and the network IC module 12 are stacked in vertical in the transformer module 1. In particularly, the network IC module 12 is set at top layer of the transformer module 1, and the transformer 11 is set at bottom layer of the transformer module 1. However, the above description is just the first embodiment. In other embodiments, the present invention can also set the network IC module 12 at the bottom layer of the transformer module 1, and set the transformer 11 at the top layer of the transformer module 1, not intended to limit the scope of the present invention.

The transformer 11 has a top side 111 and a corresponding bottom side 112. The network IC module 12 is set in parallel on the top side 111 of the transformer 11 and electrically connected with the transformer 11. In particularly, a plurality of upper terminals 113 is set on the top side 111 of the transformer 11, and the transformer 11 is electrically connected with the network IC module 12 through the plurality of upper terminals 113. Also, a plurality of lower terminals 114 is set on the bottom side 112 of the transformer 11. One end of each of the plurality of lower terminals 114 is connected with the transformer 11, and the other end of each of the plurality of lower terminals 114 is extended downward and out of the bottom of the body 13. Therefore, the transformer 11 can electrically connect with the computer mainboard 3 through the plurality of lower terminals 114, and further electrically connect with the network connector 2 through the computer mainboard 3.

As shown in FIG. 2, the network IC module 12 mainly comprises a circuit board 121, a network IC 122 and a plurality of connection terminals 123. The circuit board 121 of the network IC module 12 is set in parallel on the top side 111 of the transformer 11, and the network IC module 12 is electrically connected with the plurality of upper terminals 113 of the transformer 11 through the circuit board 121. The network IC 122 is set on the circuit board 121 and electrically connected with the transformer 11 through the circuit board 121.

In this embodiment, the network IC 122 is a local area network (LAN) IC, but not limited thereto. One end of each of the plurality of connection terminals 123 is electrically connected to the circuit board 121 separately, and the other end of each of the plurality of connection terminals 123 is extended downward and out of the bottom of the body 13. In this embodiment, the transformer module 1 is connected with an external device through the plurality of lower terminals 114 and the plurality of connection terminals 123 simultaneously. As an example, an amount of the plurality of lower terminals 114 is eight at least, an amount of the plurality of upper terminals 113 is ten at least, and an amount of the plurality of connection terminals 123 is ten at least. In this embodiment, the amount of the plurality of lower terminals 114 is according to the amount of terminals (not shown) of the network connector 2, the amount of the plurality of upper terminals 113 is according to the amount of input/output pins (not shown) of the network IC 122, and also, the amount of the plurality of connection terminals 123 is according to the amount of the input/output pins (not shown) of the network IC 122, too. However, above description is just a preferred embodiment, not intended to limit the scope of the present invention.

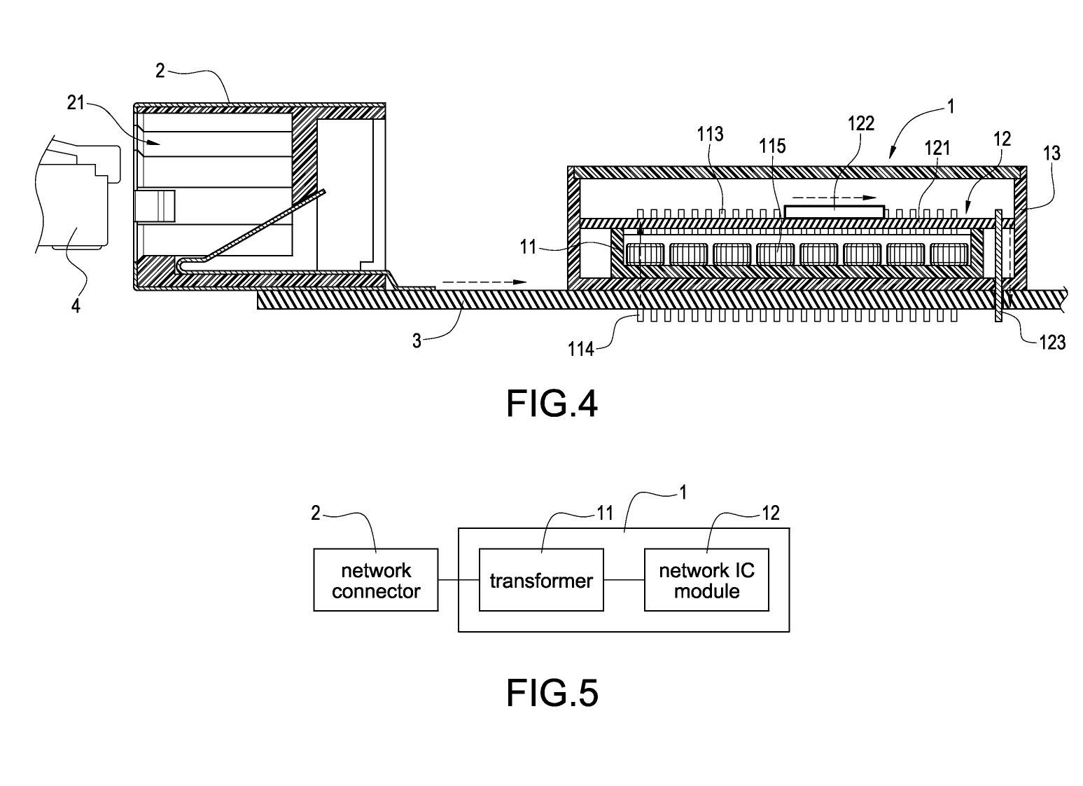

FIG. 4 is a section view of the transformer module of the first embodiment according to the present invention. FIG. 5 is a block diagram of the transformer module of the first embodiment according to the present invention. The transformer module 1 is electrically connected to the computer mainboard 3 by way of the plurality of lower terminals 114 and the plurality of connection terminals 123. As shown in FIG. 5, the network connector 2 is electrically connected to the transformer module 1 by way of the computer mainboard 3, so as to connect with the transformer 11 and the network IC module 12 of the transformer module 1 in order, and further connect with another electronic components (not shown) configured on the computer mainboard 3.

As shown in FIG. 4, the network connector 2 is configured on the computer mainboard 3, and a connection port 21 of the network connector 2 can be inserted by one end of a cable 4. An electronic device (not shown) connected to the other end of the cable 4 can connect with the network connector 2 through the cable 4, and transmit electrical signal (such as network related signal) with the network connector 2. The network connector 2 transmits the received signal to the computer mainboard 3, and the computer mainboard 3 transmits the received signal to the transformer 11 of the transformer module 1 through the plurality of lower terminals 114 for executing noise filtering. Then, the filtered signal is transmitted from the transformer 11 to the network IC module 12 through the plurality of upper terminals 113, and the network IC 122 of the network IC module 12 processes network related signal. The processed signal is then transmitted from the network IC module 12 to the computer mainboard 3 through the plurality of connection terminals 123, and the other electronic components (not shown) configured on the computer mainboard 3 can process and use the received signal. Following the above transmission order, the electronic device connected to the cable 4 can transmit the network related signal to a computer which has the computer mainboard 3, and the computer can process and use the received network related signal, so as to connect with the internet.

On the contrary, the above transmission order is reversed when signal is transmitted externally from the computer mainboard 3. In particularly, the signal is first transmitted from the computer mainboard 3 to the network IC module 12 through the plurality of connection terminals 123, then transmitted from the network IC module 12 to the transformer 11 through the plurality of upper terminals 113, and then transmitted from the transformer 11 to the computer mainboard 3 through the plurality of lower terminals 114. Therefore, the computer mainboard 3 can finally transmit the signal to the network connector 2.

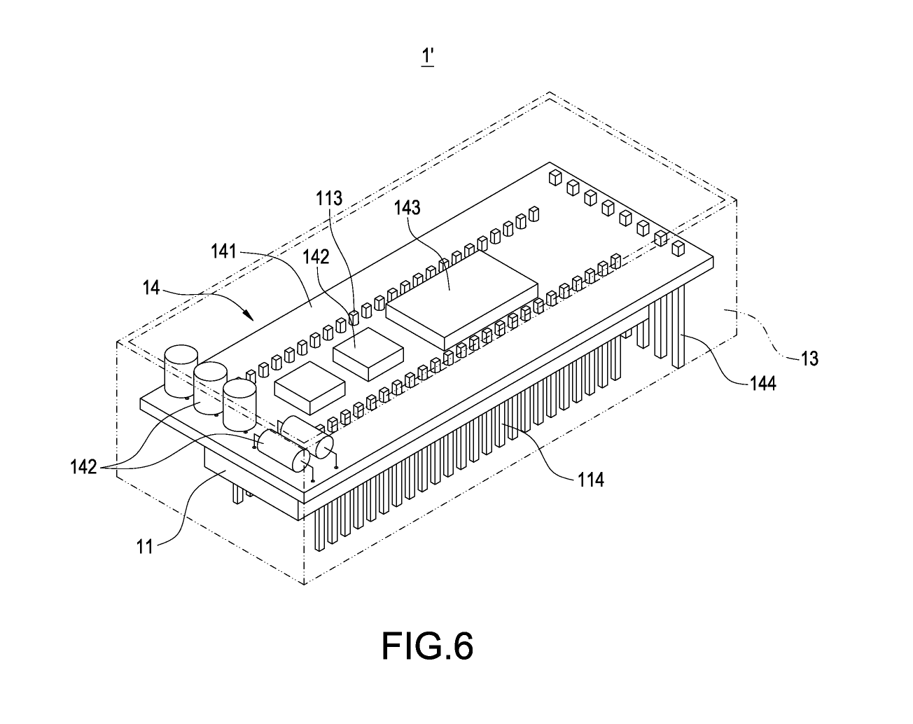

FIG. 6 is a section view of the transformer module of a second embodiment according to the present invention. This embodiment discloses another transformer module 1′. The difference between the transformer module 1′ and the above disclosed transformer module 1 is the transformer module 1′ replaces the network IC module 12 with a component integrated module 14.

In this embodiment, the component integrated module 14 mainly comprises a circuit board 141, at least one protection component 142, a network IC 143, and a plurality of connection terminals 144. The at least one protection component 142 and the network IC 143 are electrically connected with the circuit board 141, and further electrically connected with the transformer 11 of the transformer module 1′ through the circuit board 141. In particularly, the at least one protection component 142 and the network IC 143 are electrically connected with the transformer 11 through the circuit board 141 and the plurality of upper terminals 113 of the top side 111 of the transformer 11.

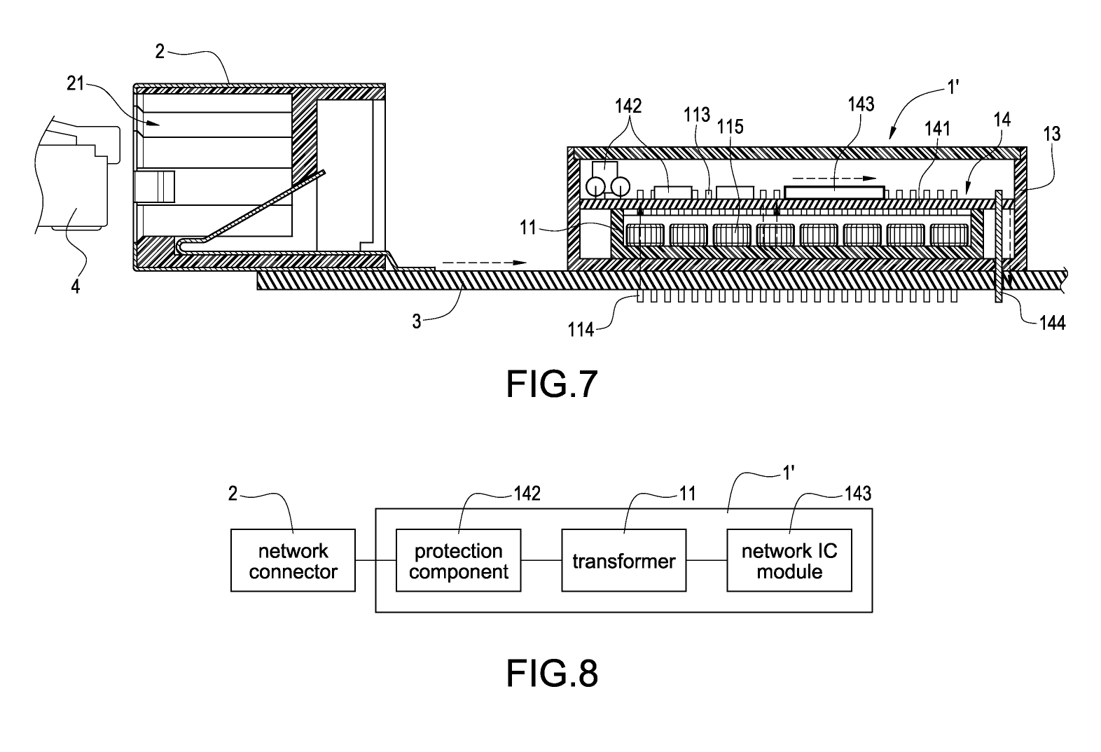

FIG. 7 is a section view of the transformer module of the second embodiment according to the present invention. FIG. 8 is a block diagram of the transformer module of the second embodiment according to the present invention. One end of each of the plurality of connection terminals 144 is electrically connected to the circuit board 141 separately, and the other end of each of the plurality of connection terminals 144 is extended downward and out of the bottom of the body 13. As shown in FIG. 7, the transformer module 1′ is electrically connected with the computer mainboard 3 through the plurality of lower terminals 114 and the plurality of connection terminals 144.

In this embodiment, the network connector 2 first transmits signal to the computer mainboard 3 after receiving the signal from the cable 4. The computer mainboard 3 then transmits the received signal to the plurality of upper terminals 113 directly through the plurality of lower terminals 114, and further transmits the signal to the at least one protection component 142 of the component integrated module 14 through the plurality of upper terminals 113. Therefore, the at least one protection component 142 can execute protective function for the received signal.

In this embodiment, the at least one protection component 142 can be, for example, a resistance, a capacitance, a transient voltage suppressor (TVS), or a gas discharge tube (GDT). Furthermore, the component integrated module 14 comprises electrical circuit set on the circuit board 141 for constituting series circuit/parallel circuit of the at least one protection components 142 on the circuit board 141. Therefore, the computer mainboard 3 can be avoided from the situation of being burned when the network connector 2 suffers external lightning stroke or surge. However, the above description is just a preferred embodiment, not intended to limit the scope of the present invention.

The at least one protection component 142 transmits the processed signal back to the transformer 11 through the plurality of upper terminals 113 for executing noise filtering. The filtered signal is then transmitted from the transformer 11 to the component integrated module 14 again through the plurality of upper terminals 113, and the network IC 143 of the component integrated module 14 processes network related signal. Finally, the processed signal is transmitted from the component integrated module 14 to the computer mainboard 3 through the plurality of connection terminals 144, and the other electronic components (not shown) configured on the computer mainboard 3 can process and use the received signal.

As shown above, the electronic device connected with the other end of the cable 4 can transmit network related signal to the network connector 2 through the cable 4, the network related signal is transmitted from the network connector 2 to the computer mainboard 3 through the at least one protection component 142, the transformer 11 and the network IC 143 in order. Therefore, the network related signal can finally reach the computer mainboard 3 and being used and processed by the computer of the computer mainboard 3, and vice versa.

Although the present invention has been described with reference to the foregoing preferred embodiments, it will be understood that the invention is not limited to the description thereof. Any equivalent variations and modifications can be made to those skilled in the art in view of the teaching of the present invention are also in the scope of the invention as defined in the appended claims.

What is claimed is:

1. A transformer module, comprising:
a transformer having a top side and a corresponding bottom side;
a network IC module, configured in parallel on the top side of the transformer and electrically connected with the transformer; and
a body having a containing space, the containing space encapsulating the transformer and the network IC module;
wherein, a plurality of lower terminals is set on the bottom side of the transformer, one end of each of the plurality of lower terminals being electrically connected with the transformer, and the other end of each of the plurality of lower terminals being extended downward and out of bottom of the body.

2. The transformer module according to claim 1, wherein the transformer comprises a plurality of upper terminals set on the top side, and the transformer is electrically connected to the network IC module through the plurality of upper terminals.

3. The transformer module according to claim 2, wherein the transformer is a transformer IC or a modularized transformer constituted by multiple coils.

4. The transformer module according to claim 3, wherein the network IC module comprises a circuit board, a plurality of connection terminals, and a network IC, wherein the circuit board is electrically connected to the plurality of upper terminals of the transformer, the network IC is electrically connected to the circuit board, and further connected to the plurality of upper terminals through the circuit board, one end of each of the plurality of connection terminals is electrically connected to the circuit board separately, and the other end of each of the plurality of connection terminals is extended downward and out of the body.

5. The transformer module according to claim 4, wherein an amount of the plurality of lower terminals is at least eight, an amount of the plurality of upper terminals is at least ten, and an amount of the plurality of connection terminals is at least ten.

6. A transformer module, comprising:
a transformer having a top side and a corresponding bottom side;
a component integrated module, configured in parallel on the top side of the transformer and electrically connected with the transformer; and
a body having a containing space, the containing space encapsulating the transformer and the component integrated module;
wherein, the component integrated module comprising a network IC and at least one protection component, and the transformer is electrically connected with the network IC and the at least one protection component of the component integrated module.

7. The transformer module according to claim 6, wherein the transformer comprises a plurality of upper terminals set on the top side, and comprises a plurality of lower terminals set on the bottom side, wherein the transformer is electrically connected to the component integrated module through the plurality of upper terminals, one end of each of the plurality of lower terminals is connected with the transformer separately, and the other end of each of the plurality of lower terminals is extended downward and out of the bottom of the body.

8. The transformer module according to claim 7, wherein the transformer is a transformer IC or a modularized transformer constituted by multiple coils.

9. The transformer module according to claim 8, wherein the component integrated module further comprises a circuit board and a plurality of connection terminals, wherein the network IC and the at least one protection component are set on the circuit board and connected with the plurality of upper terminals through the circuit board, one end of each of the plurality of connection terminals is electrically connected with the circuit board separately, and the other end of each of the plurality of connection terminals is extended downward and out of the bottom of the body.

10. The transformer module according to claim 9, wherein the at least one protection component is a resistance, a capacitance, a transient voltage suppressor (TVS), or a gas discharge tube (GDT).
